(19) United States
(12) Patent Application Publication
(10) Pub. No.: US 2011/0248198 A1
(43) Pub. Date: Oct. 13, 2011

(54) HIGH-PRESSURE ARMATURE SET OF SOLENOID VALVE

(76) Inventor: Yin-Hsiang HUANG, Kwei Shan Hsiang (TW)

(21) Appl. No.: 12/755,778

(22) Filed: Apr. 7, 2010

(51) Int. Cl. F16K 31/02

(52) U.S. Cl. 251/129.15

(57) ABSTRACT

A high-pressure armature set of a fluid solenoid valve features that a plunger has an extended portion or a balance seat that is received by a degaussing rod having an excitation element or by the armature tube, so as to balance pressure of a primary inlet at two ends of the plunger. The plunger has an axial through hole allowing fluid coming from an outlet end to reach a front end of the plunger so as to balance pressure of a secondary outlet at the two ends of the plunger. Thereby, the armature set is adaptive to a solenoid valve with larger fluid pressure without increasing the solenoid valve body in size. The extended portion of plunger or the balance seat enters the degaussing rod or the armature tube, so the attraction the degaussing rod acts on the plunger is increased and power consumption caused by coil excitation is reduced.

### BACKGROUND OF THE INVENTION

1. Technical Field

The present invention relates to a high-pressure armature set of a fluid solenoid valve. In the prevention, a plunger of the solenoid valve has a front end thereof or a balance seat thereon received in a degaussing rod having an excitation element or the armature tube, so that pressure balance of a primary inlet at two ends of the plunger can be achieved. In addition, the plunger has an axial through hole, so that pressure balance of a secondary outlet at two ends of the plunger can be also achieved. Thereby, the present invention is adaptive to a fluid solenoid valve with greater pressure, without needing to increase the solenoid valve body in size. While the plunger has the extended portion at the front end thereof or the balance seat thereon received in the degaussing rod having the excitation element or the armature tube, the degaussing rod serves to increase magnetic attraction to the plunger and thus helps to reduce power consumption caused by coil excitation.

2. Description of Related Art

Fluid solenoid valves are known as flow and pressure control valves for fluid of gas or liquid. As known in the art, such equipment serves to adjust and modulate gas or liquid from a supply end and then deliver the gas or liquid with desired stable pressure and flow at an outlet end. The principle thereof is that an armature set of the solenoid valve has solenoid coil provided at one end thereof and has a plunger and a return spring therein so that displacement of the plunger can be controlled by the solenoid coil that can attract or release the plunger, together with the return spring that provides a return force to the plunger. The diaphragm at the terminal of the plunger is accordingly driven to open or close the adjacent orifice, thereby modulating and controlling the pressure and flow of the gas or liquid.

While the above-mentioned prior-art device is a competent and wildly adopted approach to fluid control, in view of the pressure presented by the fluid at the inlet end, the return spring has to be large. Moreover, with the limitation related to the size and genetic attraction thereof, an average solenoid valve body with a diameter ranging from ½″ to 2″ is only adaptive to fluid with a pressure ranging from 0 to 50 Bar. Only when the size of the solenoid valve body is significantly decreased, the applicable pressure range can be improved. However, doing so would conflict with the desirable of mechanical compactness.

Conventionally, the applicable pressure range of a solenoid valve is subject to the diameter of the solenoid valve port. That is, the greater diameter or size of the port leads to the improved applicable range and reduced effective pressure control value. Differently, the present invention serves to improve the pressure control range while being adaptive to different types of solenoid valves, including Y-type and 2/2 way solenoid valves.

On the other hand, due to the pressure of the fluid at the inlet end and the counter spring force, the solenoid valve needs to have relatively large attraction for driving the plunger to perform expected travel. Thus, the reaction thereof is obviously slow, causing differences of time and travel between the controlling instruction and the actual performance of the solenoid valve. Consequently, the accuracy and reliability of the control are significantly reduced.

### BRIEF SUMMARY OF THE INVENTION

In view of the shortcomings of the conventional fluid control valve, the inventor of the present invention herein proposes a commercially beneficial high-pressure fluid control mechanism which allows a normal solenoid valve with a port diameter ranging from ½″ to 2″ to be adaptive to a pressure range from 0 to 70 Bar (obviously surpass the prior art which is only adaptive to the range from 0 to 50 Bar) without increasing the body diameter

The high-pressure armature assembly of the present invention lies on the principle that the plunger at a secondary outlet of the solenoid valve has a front end provided with an extended portion or a balance seat that enters a degaussing rod having an excitation element or the armature tube, so the exited coil magnetic attraction acting on the plunger is increased, and pressure of a primary inlet at two ends of the plunger is balanced. Further, the plunger has an axial through hole that allows fluid from an outlet end to flow into the front end of the plunger so that pressure of a secondary outlet at the two ends of the plunger is balanced. Thereby, the plunger assembly is adaptive to control for fluid of larger pressure without increasing the solenoid valve body in size.

The balance seat is made of soft magnet so as to allow the balance seat to enter the armature tube and thereby improve attraction due to the reduced distance therebetween. In turn, the excited magnetic attraction can be reduced and the power of the coil can be reduced. With the distance it goes into the armature tube, its magnetic balance improves and the degaussing rod attracts the plunger to move with enhanced performance.

Therein, the plunger has an axial through hole that allows fluid coming from the outlet end to flow into the front end of the plunger. Therefore, the pressure at the terminal of the plunger resisting the input fluid and the spring force of the return spring pushing the plunger to return can achieve a certain extent of balance, so that the plunger can move under low power. Hence, the armature assembly is adaptive to fluid solenoid valve of higher pressure without increasing the solenoid valve body in size.

### BRIEF DESCRIPTION OF THE SEVERAL VIEWS OF THE DRAWINGS

The invention as well as a preferred mode of use and advantages thereof will be best understood by referring to the following detailed description of illustrative embodiments in conjunction with the accompanying drawings, wherein:

FIG. 1 is a cross-sectional view of a body of a Y-type solenoid valve according to one embodiment of the present invention;

FIG. 2 is a cross-sectional view of a body of a Y-type solenoid valve according to another embodiment of the present invention;

FIG. 3 is a cross-sectional view according to FIG. 2, showing an outlet closed;

FIG. 4 is a cross-sectional view according to FIG. 2, showing an outlet open;

FIG. 5 is a cross-sectional view of a 2/2 way solenoid valve body with its outlet closed according to another embodiment of the present invention; and

FIG. 6 is a cross-sectional view of a 2/2 way solenoid valve body with its outlet opened according to another embodiment of the present invention

### DETAILED DESCRIPTION OF THE INVENTION

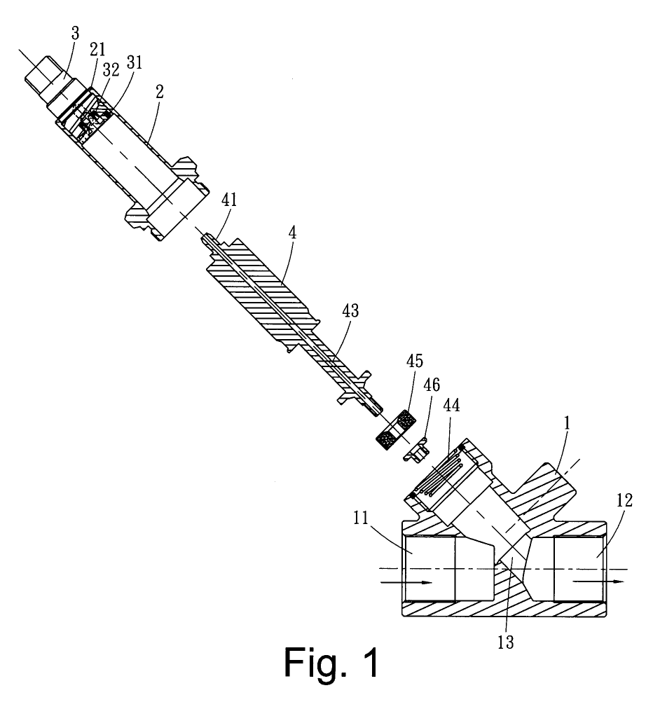

Referring to FIG. 1, according to the present invention, in a solenoid valve primarily there are a solenoid valve body 1, a armature tube 2, a degaussing rod 3 and a plunger 4, as known in the art. The present invention is characterized in that the plunger 4 received in the armature tube 2 has a front end provided with an extended portion 41 that enters a recess 32 of a degaussing rod 3 having an excitation element 31. The plunger 4 further has an axial through hole 42.

The extended portion 41 at the front end of the plunger 4 is such received in the recess 32 of the degaussing rod 3 that a lower end of the degaussing rod 3 and an upper end of the extended portion 4 of the plunger 41 are separated by a gap G.

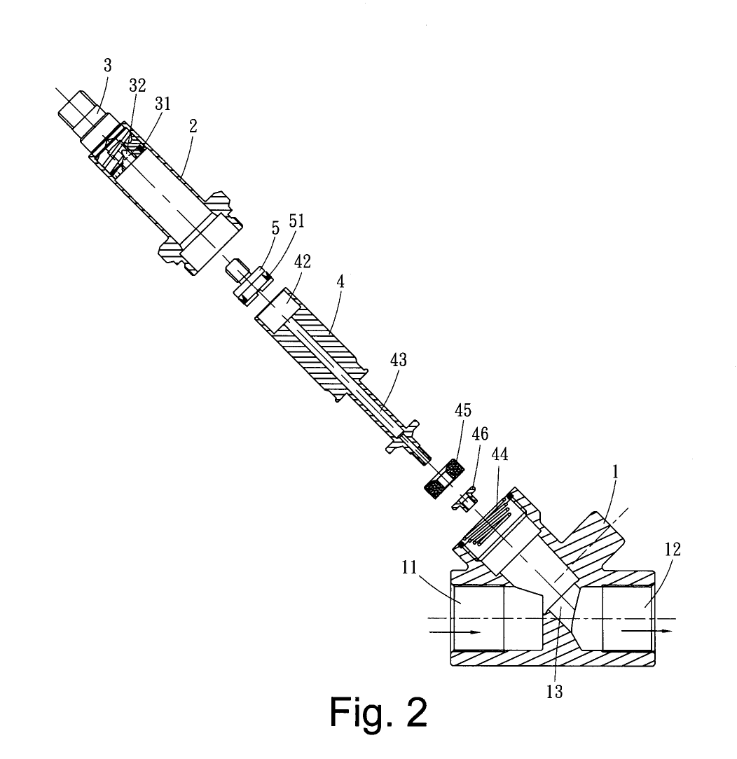

Referring to FIG. 2, in another embodiment, the plunger 4 may have its front end formed with a recess 42, and the recess 42 receives a washer 51 that holds a balance seat 5. Similarly, the lower surface of the balance seat 5 and the surface of the recess 42 are separated by a gap G. The balance seat 5 has an upper end foxed to a lower end of the degaussing rod 3 whose terminal has the excitation element 31.

The plunger 4 received in the armature tube 2 of the solenoid valve body 1 has its lower end located in a orifice 13 connecting an inlet 11 and an outlet 12 of the solenoid valve body 1. The lower end has a diaphragm 45 fixed thereto by means of a positioning sleeve 46. A retaining hook 21 is provided at a front end of the armature tube 2 for preventing the degaussing rod 3 or plunger 4 from being ejected outward in case that the armature tube 2 has cracks or leakage.

The present invention also features for an axial through hole 43 of the plunger 4. In virtue of the axial through hole 43 in the plunger 4, gas or liquid coming from the outlet end is allowed to enter the axial through hole 43 and to arrive at the gap G. As a result, the pressure of the secondary outlet at the two ends are balanced, and thus the return spring 44 at the middle portion of the plunger 4 can function with a relatively small compression ratio.

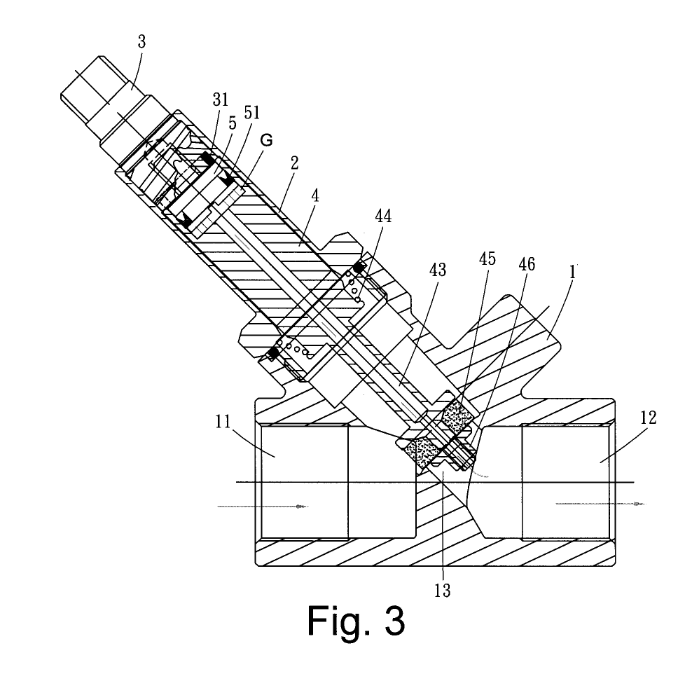

As shown in FIG. 3, in practice, when the plunger 4 is not activated by the excitation element 31, it receives a tension from the return spring 44 at the middle portion and is pushed downward so that the diaphragm 45 at the terminal closes the orifice 13 to stop output.

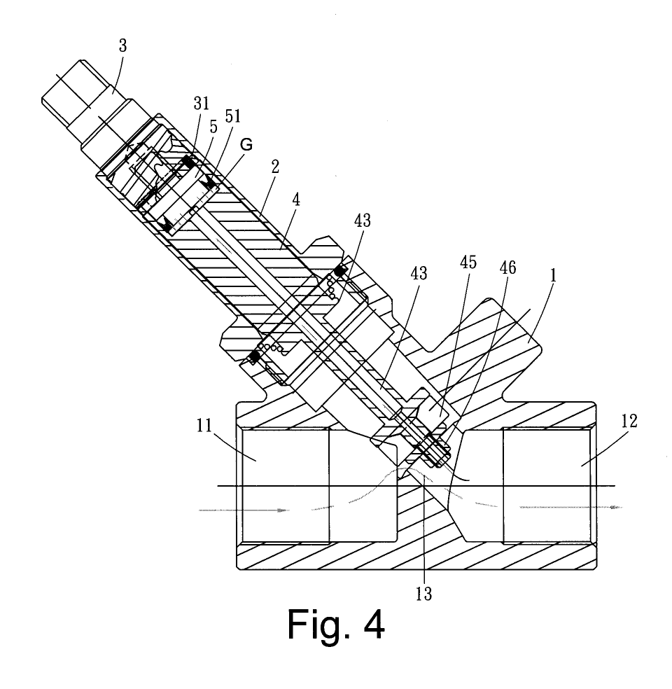

Referring to FIG. 4, when the excitation element 31 of the solenoid coil excites magnetic attraction, since the extended portion 41 of the plunger 4 or the balance seat 5 enters the recess 32 of the degaussing rod 3 or one end of the plunger 4, the magnetic attraction excited by the solenoid coil can be increased. At this time, the plunger 4 has obtained balanced pressure as described previously, the excited magnetic attraction the solenoid coil acts on the excitation element 31 can easily and sensitively draw the plunger 4 upward, so as to make the diaphragm 45 at the terminal of the plunger 4 open the orifice 13 and provide output again.

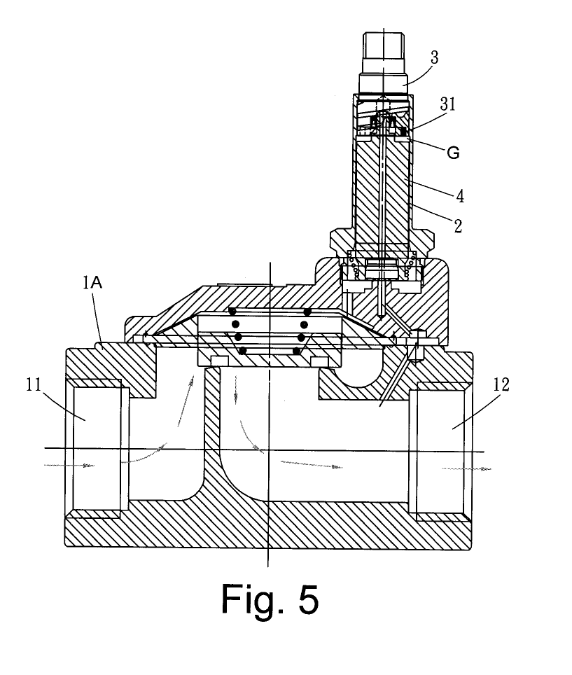

FIG. 5 is a cross-sectional drawing showing the plunger 4 with the extended portion 41 protruding from the front end thereof applied to a 2/2 way solenoid valve body 1A.

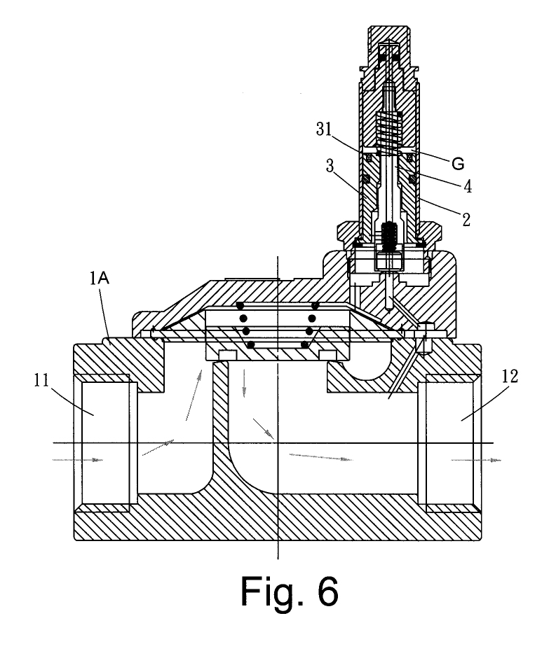

Referring to FIG. 6, to implement the armature set of the present invention, the plunger 4 may be equipped with the excitation element 31 and settled below the armature tube 2, so that the plunger 4 is drawn downward when the valve is to be opened.

Among the accompany drawings of the present invention, FIGS. 1, 5 and 6 show the embodiment where the plunger 4 has the extended portion 41 protruding from the front end thereof FIGS. 2 through 4 illustrate the plunger 4 having the recess 42 at the front end thereof to hold the balance seat 5. FIGS. 1 through 4 depict the armature set applied to the Y-type solenoid valve body 1, while FIGS. 5 and 6 show the armature set applied to the 2/2 way solenoid valve body 1A.

In virtue of the features as described above, the disclosed high-pressure armature set contributes to sensitive and accurate control while allowing improved high-pressure fluid control without the need of increasing the solenoid valve body in size. Besides, the disclosed armature set is adaptive to both the Y-type solenoid valve 1 and 2/2 way solenoid valve body 1A.

1. A high-pressure armature set of a solenoid valve, primarily comprising a solenoid valve body 1, a armature tube 2, a degaussing rod 3 and a plunger 4, and being characterized in that:
the plunger 4 received in the armature tube 2 has a front end provided with an extended portion 41 for being received in a recess 32 of a degaussing rod 3 that has an excitation element 31, and the plunger 4 has an axial through hole 42, so as to increase an excited magnetic attraction a solenoid coil acts on the plunger and to balance pressure of a secondary outlet at two ends of the plunger 4, thereby achieving sensitive and accurate control and being adaptive to a fluid solenoid valve of higher pressure without increasing the solenoid valve body in size.

2. The high-pressure armature set of claim 1, wherein the extended portion 41 of the plunger 4 is such received in the recess 32 of the degaussing rod 3 that a lower surface of the degaussing rod 3 and an upper surface of the extended portion 41 of the plunger 4 are spaced by a gap G.

3. The high-pressure armature set of claim 1, wherein the plunger 4 has a front end provided with a recess 42 for such receiving a washer 51 and a balance seat 5 held by the washer 51 that a lower surface of the balance seat 5 and a surface of the recess 42 are spaced by a gap G while an upper end of the balance seat 5 is fixed to a lower end of the degaussing rod 3 which has a terminal provided with the excitation element 31.

4. The high-pressure armature set of claim 1, wherein the plunger 4 settled in the armature tube 2 of the solenoid valve body 1 has a lower end positioned in a orifice 13 connecting the inlet 11 and the outlet 12 of the solenoid valve body 1, and a diaphragm 45 is fixed to the lower end via a positioning sleeve 46.

5. The high-pressure armature set of claim 1, wherein the plunger 4 is formed with an axial through hole 43 that allows gas or liquid coming from an outlet end of the solenoid valve to flow along the axial through hole 42 and to reach the gap G, so the pressure of the secondary outlet at the two ends of the plunger 4 gets balanced and thereby the return spring 43 in a middle portion of the plunger 4 is allowed to have small compression ratio.

6. The high-pressure armature set of claim 1, wherein the extended portion 41 of the plunger 4 or the balance seat 5 enters the recess 32 of the degaussing rod 3 or an end of the plunger 4 so as to increase the excited magnetic attraction the solenoid coil acts on the plunger.

7. The high-pressure armature set of claim 1, wherein the armature set is adaptive to a Y-type solenoid valve body 1 or a 2/2 way solenoid valve body 1A.

8. The high-pressure armature set of claim 2, wherein the plunger 4 settled in the armature tube 2 of the solenoid valve body 1 has a lower end positioned in a orifice 13 connecting the inlet 11 and the outlet 12 of the solenoid valve body 1, and a diaphragm 45 is fixed to the lower end via a positioning sleeve 46.

9. The high-pressure armature set of claim 3, wherein the plunger 4 settled in the armature tube 2 of the solenoid valve body 1 has a lower end positioned in a orifice 13 connecting the inlet 11 and the outlet 12 of the solenoid valve body 1, and a diaphragm 45 is fixed to the lower end via a positioning sleeve 46.
